(19) United States
(12) Patent Application Publication
(10) Pub. No.: US 2026/0082149 A1
(43) Pub. Date: Mar. 19, 2026

(54) SPEAKER DEVICE

(71) Applicant: PANASONIC INTELLECTUAL PROPERTY MANAGEMENT CO., LTD., Osaka (JP)

(72) Inventors: Takashi YAMAO, Osaka (JP); Isao KAKUHARI, Nara (JP); Satoshi TAKAYAMA, Mie (JP)

(21) Appl. No.: 19/394,079

(22) Filed: Nov. 19, 2025

Related U.S. Application Data
(63) Continuation of application No. PCT/JP2024/015661, filed on Apr. 19, 2024.

(30) Foreign Application Priority Data
May 26, 2023 (JP) 2023-087178

(51) Int. Cl. H04R 1/34; H04R 1/24

(52) U.S. Cl. CPC H04R 1/345; H04R 1/24

(57) ABSTRACT

[Task] To provide a speaker device capable of diffusing an inaudible range sound output from a speaker and improving directional characteristics of the inaudible range sound.

[Solution] Provided is a speaker device including a speaker that outputs an audible range sound and an inaudible range sound, and a diffusion member that is provided on a sound emission surface of the speaker and diffuses the inaudible range sound output from the speaker, in which the diffusion member is a member that propagates the audible range sound and the inaudible range sound inside.

### TECHNICAL FIELD

The present invention relates to a speaker device.

### BACKGROUND ART

Conventionally, in order to expand a range in which a listener can appropriately listen to a sound in an audible range output from a speaker, it has been studied to diffuse the audible range sound. For example, Patent Literature 1 discloses a technique for diffusing the audible range sound output from a speaker using an acoustic lens.

Furthermore, in recent years, a high resolution audio system capable of playing a sound in an inaudible range in addition to a sound in an audible range has begun to spread. An inaudible range sound has sharper directivity than an audible range sound, and a range in which a listener can appropriately listen to the inaudible range sound becomes narrower. Therefore, a technique for diffusing the inaudible range sound is also desired with the spread of high resolution audio systems.

However, no technology aimed at diffusing the inaudible range sound has been reported so far.

The present invention has been made in view of such circumstances, and an object thereof is to provide a speaker device capable of diffusing an inaudible range sound output from a speaker and improving directional characteristics of the inaudible range sound.

### CITATION LIST

### Patent Literature

Patent Literature 1: WO 2021/049136 A

### SUMMARY OF INVENTION

A speaker device according to one aspect of the present invention includes a speaker that outputs an audible range sound and an inaudible range sound, and a diffusion member that is provided on a sound emission surface of the speaker and diffuses the inaudible range sound output from the speaker, in which the diffusion member is a member that propagates the audible range sound and the inaudible range sound inside. With such a configuration, the inaudible range sound output from the speaker can be diffused, and the directional characteristics of the inaudible range sound can be improved.

### BRIEF DESCRIPTION OF DRAWINGS

FIG. 1 is a cross-sectional view schematically illustrating a configuration example of a speaker device according to the present embodiment.

### DESCRIPTION OF EMBODIMENTS

Hereinafter, embodiments according to the present invention will be specifically described, but the present invention is not limited thereto.

### [Speaker Device]

A speaker device according to the present embodiment includes a speaker that outputs an audible range sound and an inaudible range sound, and a diffusion member that is provided on a sound emission surface of the speaker and diffuses the inaudible range sound output from the speaker, in which the diffusion member is a member that propagates the audible range sound and the inaudible range sound inside. With such a configuration, the inaudible range sound output from the speaker can be diffused, and the directional characteristics of the inaudible range sound can be improved.

Note that, in the present specification, the sound emission surface of the speaker refers to a portion where an audible range sound and an inaudible range sound are output on the front surface of the speaker.

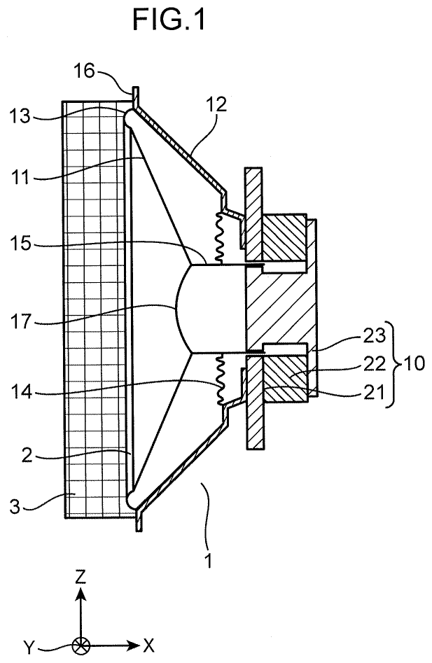

A configuration of the speaker device according to the present embodiment will be described with reference to FIG. 1 as necessary. FIG. 1 is a cross-sectional view illustrating a speaker device 1 according to the embodiment. In FIG. 1, reference numerals denote 1: speaker device, 2: speaker, 3: diffusion member, 10: magnet field part, 11: diaphragm, 12: frame, 13: edge, 14: damper, 15: voice coil body, 16: annular part, 17: center cap, 21: top plate, 22: magnet, and 23: yoke.

As illustrated in FIG. 1, the speaker device 1 includes a speaker 2 and a diffusion member 3 provided on a sound emission surface (front surface) of the speaker 2. The diffusion member 3 may be directly attached to the speaker 2, or the speaker device 1 may include a support member (not shown) that supports the diffusion member 3 and is attached to the sound emission surface of the speaker 2. For example, by attaching the diffusion member 3 to a frame formed so as to surround the sound emission surface of the speaker 2 so as to attach a known speaker net to the speaker, the diffusion member 3 can be fixed to the speaker 2.

The speaker is not particularly limited as long as it is a speaker which is compatible to high resolution and capable of outputting sounds in an audible range (for example, the frequency is less than about 20 kHz) and an inaudible range (for example, the frequency is about 20 kHz or more), and a commercially available speaker can also be used. A configuration example of the speaker will be described with reference to FIG. 1. The speaker 2 illustrated in FIG. 1 is an electroacoustic transducer that plays sound based on an input signal, and includes a diaphragm 11, a frame 12, an edge 13, a damper 14, a voice coil body 15, and a magnet field part 10. The speaker 2 may be mounted on a cabinet (not shown). Note that the speaker 2 in FIG. 1 is a conical speaker, but the speaker in the present embodiment is not limited thereto, and may be, for example, a speaker compatible to high resolution with another shape such as a ribbon type, a dome type, or a horn type.

The diaphragm 11 is a member that vibrates the air by being displaced in the front-back direction (X-axis direction in the drawing) based on neutral position based on the electric signal including the inaudible range sound, and generates a sound. In the speaker 2 illustrated in FIG. 1, the diaphragm 11 has a cone shape (truncated cone shape), and a hole is provided at the center of the diaphragm 11. The voice coil body 15 is attached to an inner peripheral edge of the diaphragm 11 (an edge of the hole). The sound emission surface of the speaker 2 is a surface passing through the outer peripheral edge of the cone-shaped diaphragm 11. The material of the diaphragm 11 is not particularly limited, but may be paper, polymer resin, metal, or the like. A center cap 17 is attached so as to close a hole provided at the center of the diaphragm 11.

The frame 12 is a structural member that holds the outer peripheral edge of the diaphragm 11 at a predetermined position. The frame 12 includes an annular part 16 disposed so as to surround the outer peripheral edge of the diaphragm 11. In the speaker 2 illustrated in FIG. 1, the frame 12 has a truncated cone shape whose diameter gradually decreases rearward (a rear direction of the speaker 2, X-axis positive direction) from the annular part 16, and a region including an end portion on a side opposite to annular part 16 (inner peripheral edge side) is fixed to the magnet field part 10.

The edge 13 is an annular member that connects the outer peripheral edge of the diaphragm 11 and the annular part 16 of the frame 12. In the speaker 2 illustrated in FIG. 1, the cross-sectional shape of the edge 13 is a substantially semicircular shape.

The damper 14 is a thin annular member that is disposed between the annular part 16 and the magnet field part 10 in the X-axis direction and connects the frame 12 and the voice coil body 15. The damper 14 is disposed substantially parallel to the sound emission surface of the speaker 2.

The voice coil body 15 has one end disposed in a magnetic gap formed in the magnet field part 10, and the other end coupled to the diaphragm 11. The voice coil body 15 generates a magnetic flux according to an input electric signal, and in the speaker 2 illustrated in FIG. 1, the voice coil body 15 includes a cylindrical bobbin and a coil wound around an outer periphery of the bobbin.

The magnet field part 10 is a member that forms a magnetic circuit for vibrating the diaphragm 11 via the voice coil body 15. In the speaker 2 illustrated in FIG. 1, the magnet field part 10 is disposed on the back side of the diaphragm 11, that is, on the side opposite to the sound emission surface of the speaker 2 with respect to the diaphragm 11. The magnet field part 10 includes a top plate 21, a magnet 22, and a yoke 23.

Next, the diffusion member is provided on a sound emission surface (front surface) of the speaker. The diffusion member may be provided so as to cover at least a part of a portion where the inaudible range sound can be output on the sound emission surface of the speaker. With this arrangement, the effect of diffusing the inaudible range sound can be obtained more reliably.

As illustrated in FIG. 1, the diffusion member 3 may be provided so as to cover the entire sound emission surface of the speaker 2. By providing in this manner, the inaudible range sound can be diffused in the same range as the audible range sound.

Further, the diffusion member may be provided so as to cover only a part of a portion of the sound emission surface of the speaker from which the inaudible range sound can be output. Specifically, for example, it may be provided so as to cover only the center portion of the diaphragm, or it may be provided so as to cover only half of a portion where the inaudible range sound can be output on the sound emission surface of the speaker. Since the diffusion member is provided so as to cover only a part of the portion where the inaudible range sound can be output on the sound emission surface of the speaker, it is possible to partially create a range in which the diffusion effect of the inaudible range sound can be obtained. Specifically, for example, by covering only the right half of the portion where the inaudible range sound can be output in the sound emission surface of the speaker by the diffusion member (for example, the diaphragm center portion), the range in which the diffusion effect can be obtained can be partially created such that the inaudible range sound is diffused on the right side of the speaker but is not diffused on the left side of the speaker.

Note that the portion from which the audible range sound can be output may or may not be covered with the diffusion member.

The diffusion member is a member that propagates the audible range sound and the inaudible range sound therein. More specifically, the diffusion member is a member having a hole or a space inside the member, and sound propagates through air inside the member. The diffusion member is not particularly limited as long as it can diffuse the inaudible range sound output from the speaker. Note that, in the present specification, a diffusion member is provided on a sound emission surface of a speaker that outputs an audible range sound and an inaudible range sound, a sound pressure of 60 kHz measured at a front position (0°) of the speaker is defined as a reference sound pressure, the reference sound pressure is subtracted from the sound pressure of 60 kHz measured by a microphone at an angle of 60° from the front, and if a subtraction value is −16 dB or less, the used diffusion member is defined to be capable of diffusing the inaudible range sound. The subtraction value is more preferably −6 dB or less, still more preferably −4 dB or less.

The diffusion member is preferably one capable of diffusing the inaudible range sound more than the audible range sound, and specific examples thereof include a three-dimensional network structure, a porous body, and a laminated structure, and the material thereof is not particularly limited. Examples of the three-dimensional network structure include a foam having a three-dimensional network skeleton without a cell membrane, and a three-dimensional network structure formed of fibers. Examples of the porous body include a ceramic porous body. The laminated structure is, for example, a laminated structure having pores or voids, and examples thereof include a laminate in which punching plates (including micropores, wire meshes, and the like) are arranged at regular intervals, and a laminate in which mesh fabrics (plain weave fabrics) are stacked. Furthermore, the material is not particularly limited, and may be any of an organic substance, an inorganic substance, a metal, and the like as long as it reflects a sound wave.

Here, examples of the foam having a three-dimensional network skeleton without a cell membrane include a polyurethane foam subjected to film removal treatment, and for example, commercially available products such as “Moltofilter” (registered trademark) manufactured by INOAC CORPORATION can be used. The polyurethane foam is not particularly limited, but the number of cells is preferably 8 to 13 per 25 mm. Within such a range, the effect of diffusing the inaudible range sound can be more reliably obtained.

Examples of the three-dimensional network structure formed of fibers include a three-dimensional random loop joined body in which a large number of continuous linear bodies are bent to form random loops and contact portions thereof are fused, and a nonwoven fabric formed of synthetic fibers.

The diffusion member preferably has an airflow resistance value in a range of 0.0020 to 0.0090 kPa s/m. If the airflow resistance value is too small, the inaudible range sound may not be sufficiently diffused. On the other hand, when the airflow resistance value is too large, both the audible range sound and the inaudible range sound are difficult to pass through, and there is a possibility that the sound cannot be sufficiently propagated. Therefore, when the airflow resistance value is in a range of 0.0020 to 0.0090 kPa s/m, the inaudible range sound can be more reliably diffused than the audible range sound, and the directional characteristics of the inaudible range sound can be more reliably improved.

The airflow resistance value is more preferably 0.0080 kPa·s/m or less, still more preferably 0.0060 kPa s/m or less, and most preferably 0.0023 kPa·s/m or less. The airflow resistance value is more preferably 0.0021 kPa s/m or more. The airflow resistance value refers to an airflow resistance value measured using an air permeability tester (for example, an air permeability tester KES-F8 manufactured by Kato Tech Co., Ltd.). For example, the airflow resistance value can be measured by a method described later in examples.

The diffusion member may be formed of a single member. More specifically, for example, the diffusion member may be formed of a single member having a uniform airflow resistance value, a single member having a uniform density, or the like. Further, the diffusion member may be configured by combining a plurality of different members.

Further, the diffusion member may include a portion having a partially different airflow resistance value. Even in such a case, the airflow resistance value of the entire diffusion member is preferably 0.0020 to 0.0090 kPa·s/m. When the diffusion member includes a portion having a partially different airflow resistance value, it is preferable that the airflow resistance value of a portion close to the sound emission surface of the speaker be smaller than the airflow resistance value of a portion far from the sound emission surface of the speaker in the thickness direction of the diffusion member. That is, it is preferable that, in the thickness direction of the diffusion member, the airflow resistance value is configured to be smaller as it is closer to the sound emission surface of the speaker. With such a configuration, the effect of diffusing the inaudible range sound can be further improved.

The diffusion member may include a portion having a partially different density. Even in such a case, the airflow resistance value of the entire diffusion member is preferably 0.0020 to 0.0090 kPa s/m. In a case where the diffusion member includes a portion having a partially different density, it is preferable that a density of a portion close to the sound emission surface of the speaker be smaller than a density of a portion far from the sound emission surface of the speaker in the thickness direction of the diffusion member. That is, it is preferable that, in the thickness direction of the diffusion member, the density is configured to be smaller as it is closer to the sound emission surface of the speaker. With such a configuration, the effect of diffusing the inaudible range sound can be further improved.

The size and shape of the diffusion member are not particularly limited, and can be appropriately set according to the size and shape of the speaker to be used. Furthermore, the hardness and thickness of the diffusion member are not particularly limited as long as the inaudible range sound output from the speaker can be diffused, but the thickness is preferably set so that the airflow resistance value of the diffusion member is 0.0020 to 0.0090 kPa·s/m.

In addition, it is preferable that a sound having a frequency of 40 to 80 kHz is diffused by using the diffusion member. It is known that by receiving an inaudible range sound, particularly a sound with a frequency of 40 to 80 kHz, the brain is activated and a relaxation effect is obtained. Therefore, by diffusing the sound having a frequency of 40 to 80 kHz, the sound reception range in which the relaxation effect can be obtained can be expanded.

This specification discloses techniques in various aspects as described above, and the main techniques among them are summarized below.

A speaker device according to a first aspect includes a speaker that outputs an audible range sound and an inaudible range sound, and a diffusion member that is provided on a sound emission surface of the speaker and diffuses the inaudible range sound output from the speaker, in which the diffusion member is a member that propagates the audible range sound and the inaudible range sound inside.

The speaker device according to a second aspect is the speaker device according to the first aspect in which the diffusion member has an airflow resistance value of 0.0020 to 0.0090 kPa·s/m.

A speaker device according to a third aspect is the speaker device according to the first or second aspect in which the frequency of the inaudible range sound is 40 to 80 KHz.

A speaker device according to a fourth aspect is the speaker device according to any one of the first to third aspects in which the diffusion member includes at least one selected from the group consisting of a three-dimensional network structure, a porous body, and a laminated structure.

A speaker device according to a fifth aspect is the speaker device according to any one of the first to fourth aspects in which the diffusion member is provided so as to cover at least a part of a portion where an inaudible range sound is output on a sound emission surface of the speaker.

A speaker device according to a sixth aspect is the speaker device according to any one of the first to fifth aspects in which the diffusion member is provided so as to cover an entire sound emission surface of the speaker.

A speaker device according to a seventh aspect is the speaker device according to any one of the first to sixth aspects in which the diffusion member includes a portion having a partially different airflow resistance value, and the airflow resistance value of a portion close to the sound emission surface of the speaker is smaller than the airflow resistance value of a portion far from the sound emission surface of the speaker in the thickness direction of the diffusion member.

Hereinafter, the present invention will be described more specifically with reference to examples, but the scope of the present invention is not limited thereto.

### EXAMPLES

In order to confirm the effect according to the present embodiment, that is, the effect (directional characteristics) that can diffuse the inaudible range sound output from the speaker, the following Examples and Comparative Examples are performed. Note that the directional characteristics of the inaudible range sound in the speaker have been evaluated as follows.

### (Evaluation of Directional Characteristics)

At the front position (0°) of the speaker where the audible range sound and the inaudible range sound are output, the measured sound pressure of 60 KHz has been set as the reference sound pressure, and the reference sound pressure has been subtracted from the sound pressure of 60 kHz measured by the microphone at an angle of 60° from the front. When the subtraction value has been −16 dB or less, it has been evaluated that the directional characteristics of the inaudible range sound in the speaker have been improved.

### Example 1

As Example 1, Sample 1 (nonwoven fabric of nylon or polyester fiber, product name: Scotch Bright (registered trademark) rough scrubbing grain, manufactured by 3M Japan Ltd.) has been installed as a diffusion member on a sound emission surface of a speaker (product name: EAS3FP25A manufactured by Panasonic Corporation) that outputs an audible range sound and an inaudible range sound. At this time, Sample 1 has been placed so as to cover the entire sound emission surface of the speaker.

The airflow resistance value of Sample 1 has been measured using an air permeability tester (KES-F8) manufactured by Kato Tech Co., Ltd. The measurement has been performed under the conditions of an air flow rate of 4 cc/sec and a pressure output sensitivity of 200 Pa (high sensitivity). The number of measurements has been set to N=5, and an average value thereof has been obtained. As a result of the measurement, the airflow resistance value of Sample 1 has been 0.0022 kPa·s/m.

The results of evaluating the directional characteristics of the speaker as described above are shown in Table 1.

### Example 2

As Example 2, the directional characteristics have been evaluated in the same manner as in Example 1 except that Sample 2 (polyester-based urethane foam subjected to film removal treatment, number of cells: 8/25 mm, product name: MF-8, manufactured by INOAC CORPORATION) has been used instead of Sample 1 in Example 1. In addition, as a result of measuring the airflow resistance value of Sample 2 in the same manner as in Example 1, the airflow resistance value of Sample 2 has been 0.0020 kPa s/m. The evaluation results are presented in Table 1.

### Example 3

As Example 3, the directional characteristics have been evaluated in the same manner as in Example 1 except that Sample 3 (polyester-based urethane foam subjected to film removal treatment, number of cells: 13/25 mm, product name: MF-13, manufactured by INOAC CORPORATION) has been used instead of Sample 1 in Example 1. In addition, as a result of measuring the airflow resistance value of Sample 3 in the same manner as in Example 1, the airflow resistance value of Sample 3 has been 0.0085 kPa·s/m. The evaluation results are presented in Table 1.

### Comparative Example 1

As Comparative Example 1, the directional characteristics have been evaluated in the same manner as in Example 1 except that Sample 4 (polyester-based urethane foam subjected to film removal treatment, number of cells: 20/25 mm, product name: MF-20, manufactured by INOAC CORPORATION) has been used instead of Sample 1 in Example 1. In addition, as a result of measuring the airflow resistance value of Sample 4 in the same manner as in Example 1, the airflow resistance value of Sample 4 has been 0.0141 kPa s/m. The evaluation results are presented in Table 1.

### Comparative Example 2

As Comparative Example 2, the directional characteristics have been evaluated in the same manner as in Example 1 except that Sample 5 (three-dimensional random loop joined body in which polyether ester elastomer fibers are connected in a three-dimensional direction while drawing many loops, product name: Breath Air (registered trademark), manufactured by Toyobo Co., Ltd.) has been used instead of Sample 1 in Example 1. In addition, as a result of measuring the airflow resistance value of Sample 5 in the same manner as in Example 1, the airflow resistance value of Sample 5 has been 0.0019 kPa s/m. The evaluation results are presented in Table 1.

### Comparative Example 3

As Comparative Example 3, the directional characteristics have been evaluated in the same manner as in Example 1 except that Sample 6 (nonwoven fabric of polyester fiber, product name: Travelon (registered trademark) air filter AF200AR, manufactured by Kanai Juyo Kogyo Co., Ltd) has been used instead of Sample 1 in Example 1. In addition, as a result of measuring the airflow resistance value of Sample 6 in the same manner as in Example 1, the airflow resistance value of Sample 6 has been 0.0550 kPa·s/m. The evaluation results are presented in Table 1.

### Comparative Example 4

As Comparative Example 4, the directional characteristics have been evaluated in the same manner as in Example 1 except that Sample 1 in Example 1 has not been installed. The evaluation results are presented in Table 1.

TABLE 1

| | | | | Comparative | Comparative | Comparative | Comparative |
|---|---|---|---|---|---|---|---|
| | Example 1 | Example 2 | Example 3 | Example 1 | Example 2 | Example 3 | Example 4 |
| Sample | Sample 1 | Sample 2 | Sample 3 | Sample 4 | Sample 5 | Sample 6 | — |
| Airflow resistance value of | 0.0022 | 0.0020 | 0.0085 | 0.0141 | 0.0019 | 0.0550 | — |
| sample (kPa · s/m) | | | | | | | |
| Directional characteristics | −4 | −14 | −16 | −19 | −20 | −24 | −22 |
| (subtraction value of sound | | | | | | | |
| pressure: dB) | | | | | | | |

In Examples 1 to 3, by using the diffusion member of the present invention, the subtraction value of the sound pressure is suppressed to −16 dB or less, and it can be confirmed that the inaudible range sound output from the speaker is diffused. On the other hand, in Comparative Examples 1 to 3, the subtraction value of the sound pressure has been a value larger than-16 dB, and the diffusion effect of the inaudible range sound by the diffusion member used in Comparative Examples 1 to 3 has been low. In addition, in Comparative Example 4, since the diffusion member has not been used, the diffusion effect of the inaudible range sound could not be obtained.

This application is based on Japanese Patent Application No. 2023-087178 filed on May 26, 2023, and the contents of which are included in the present application.

In order to express the present invention, the present invention has been described above appropriately and sufficiently through the embodiments with reference to specific examples, drawings and the like. However, it should be recognized by those skilled in the art that changes and/or improvements of the above-described embodiments can be readily made. Accordingly, changes or improvements made by those skilled in the art shall be construed as being included in the scope of the claims unless otherwise the changes or improvements are at the level which departs from the scope of the appended claims.

### INDUSTRIAL APPLICABILITY

According to the present invention, it is possible to provide a speaker device capable of diffusing an inaudible range sound output from a speaker and improving directional characteristics of the inaudible range sound.

1. A speaker device comprising:
a speaker that outputs an audible range sound and an inaudible range sound; and
a diffusion member that is provided on a sound emission surface of the speaker and diffuses the inaudible range sound output from the speaker,
wherein the diffusion member is a member that propagates the audible range sound and the inaudible range sound inside.

2. The speaker device according to claim 1, wherein the diffusion member has an airflow resistance value of 0.0020 to 0.0090 kPa·s/m.

3. The speaker device according to claim 1, wherein a frequency of the inaudible range sound is 40 to 80 KHz.

4. The speaker device according to claim 1, wherein the diffusion member includes at least one selected from the group consisting of a three-dimensional network structure, a porous body, and a laminated structure.

5. The speaker device according to claim 1, wherein the diffusion member is provided so as to cover at least a part of a portion of a sound emission surface of the speaker from which the inaudible range sound is output.

6. The speaker device according to claim 1, wherein the diffusion member is provided so as to cover an entire sound emission surface of the speaker.

7. The speaker device according to claim 1, wherein
the diffusion member includes a portion having a partially different airflow resistance value, and
in a thickness direction of the diffusion member, an airflow resistance value of a portion close to the sound emission surface of the speaker is smaller than an airflow resistance value of a portion far from the sound emission surface of the speaker.
